(19) United States
(12) Patent Application Publication
(10) Pub. No.: US 2002/0135999 A1
(43) Pub. Date: Sep. 26, 2002

(54) Illuminator with pull cord

(76) Inventor: Chung-Yang M. Chen, Hsintien City (TW)

Correspondence Address: DOUGHERTY & TROXELL, SUITE 1404, 5205 LEESBURG PIKE, FALLS CHURCH, VA, 22041, US

(21) Appl. No.: 09/813,313

(22) Filed: Mar. 21, 2001

(51) Int. Cl. F21V 33/00

(52) U.S. Cl. 362/116; 362/109; 362/253; 362/398; 362/208

(57) ABSTRACT

Illuminator with pull cord, including a casing, a base seat, a light emitting unit and a pull device. The base seat is mated with the casing to define therebetween a chamber. One end of the casing is transparent or semitransparent, in which a light source is disposed. The pulling device is arranged in a receptacle of the base seat and composed of a resilient member and a cord reel unit connected therewith. A pull cord is wound around the cord reel unit with one end extending out of the casing to connect with a fastening member which can be fastened on a wear or an article carried by a user. After used, the resilient member through the pull cord automatically pulls back and restore the illuminator to its home position.

### BACKGROUND OF THE INVENTION

The present invention is related to an illuminator with pull cord, and more particularly to an illuminator including a pulling device composed of a resilient member and a cord reel unit connected therewith. After used, the resilient member through the pull cord automatically pulls back and restore the illuminator to its home position.

A conventional portable illuminator such as a flashlight generally includes a cylindrical body in which cells are disposed. A bulb is mounted at one end of the cylindrical body to serve as a light source. When turned on, the bulb emits light to provide an illumination effect. When carrying such portable illuminator, a user often needs to keep holding the illuminator. Therefore, it is inconvenient for the user to carry such portable illuminator with him/her.

### SUMMARY OF THE INVENTION

It is therefore a primary object of the present invention to provide an illuminator with pull cord, including a casing and a base seat mated with the casing to define therebetween a chamber. A light source, a cell and a pulling device are disposed in the chamber. The pulling device is composed of a resilient member and a cord reel unit connected therewith. A pull cord is wound around the cord reel unit with one end extending out of the casing to connect with a fastening member which can be fastened on a wear or an article carried by a user, When used, a user can pull the illuminator from his/her body toward a place to be illuminated. After used, the resilient member through the pull cord automatically pulls back and restore the illuminator to its home position. Such operation is simple and the illuminator is prevented from accidentally dropping. Therefore, the user can more conveniently use and carry the illuminator.

The present invention can be best understood through the following description and accompanying drawings wherein:

### BRIEF DESCRIPTION OF THE DRAWINGS

FIG. 1 is a perspective exploded view of the illuminator of the present invention;

FIG. 2 is a perspective partially exploded view of the illuminator of the present invention;

FIG. 3 is a plane partially sectional view of the illuminator of the present invention;

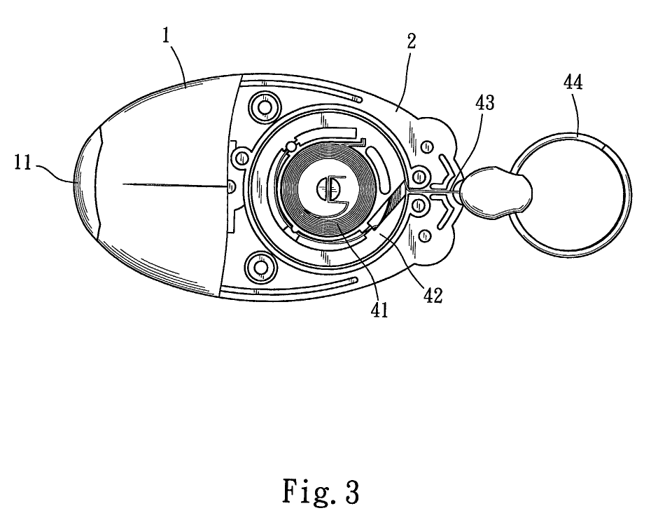

FIG. 4 is a view according to FIG. 3, showing the operation of the illuminator of the present invention;

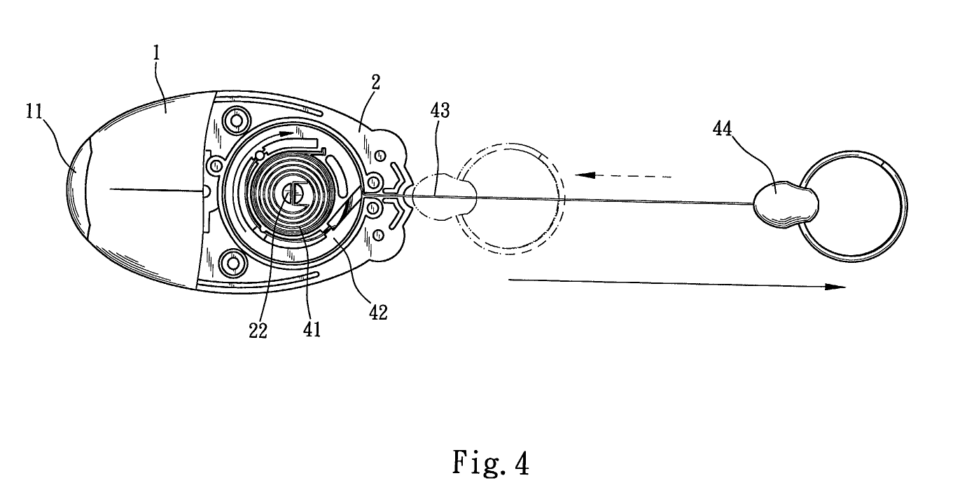

FIG. 5 shows that the illuminator of the present invention is used to emit light;

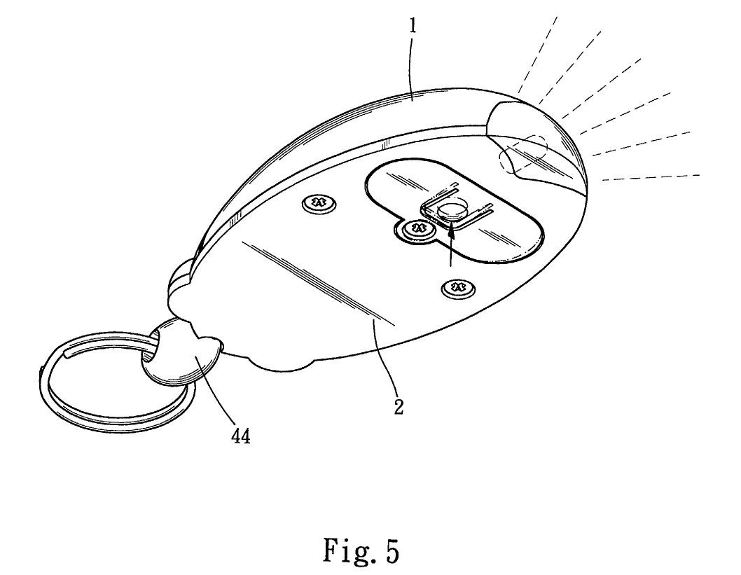

FIG. 6 is a perspective view of another embodiment of the illuminator of the present invention, showing the operation thereof; and

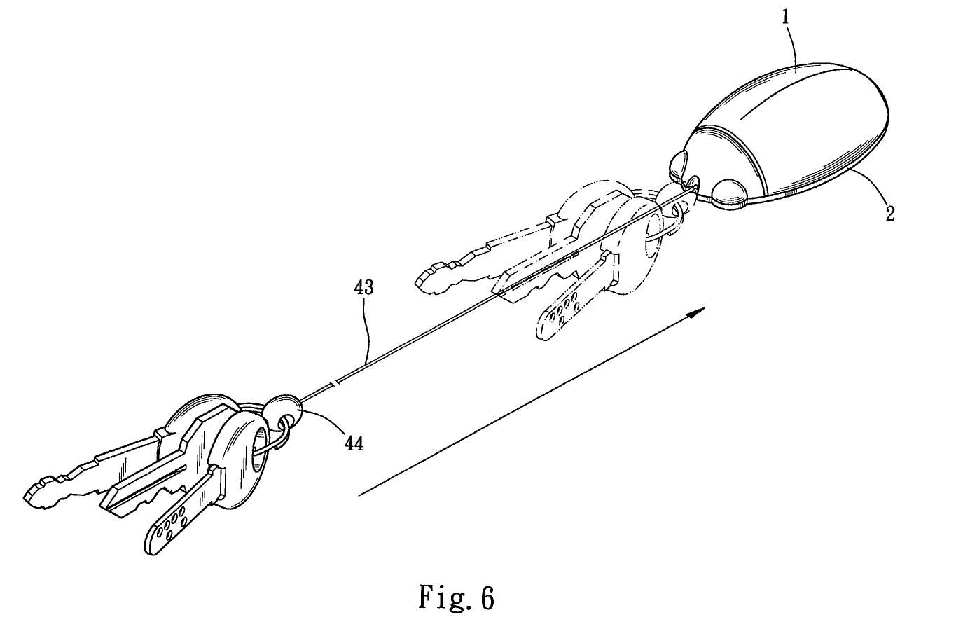

FIG. 7 is a perspective view of still another embodiment of the illuminator of the present invention.

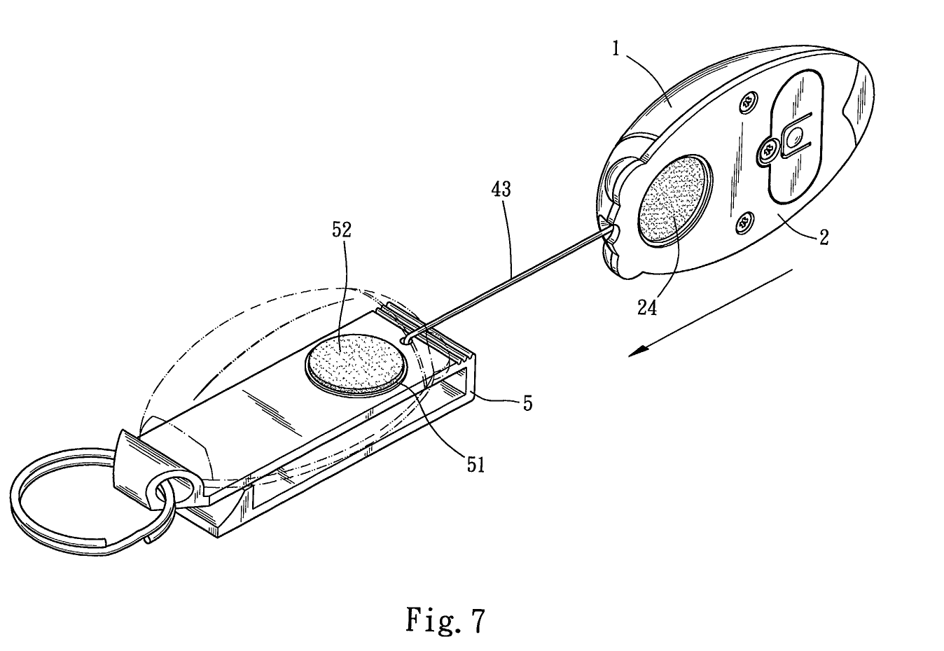

### DETAILED DESCRIPTION OF THE PREFERRED EMBODIMENTS

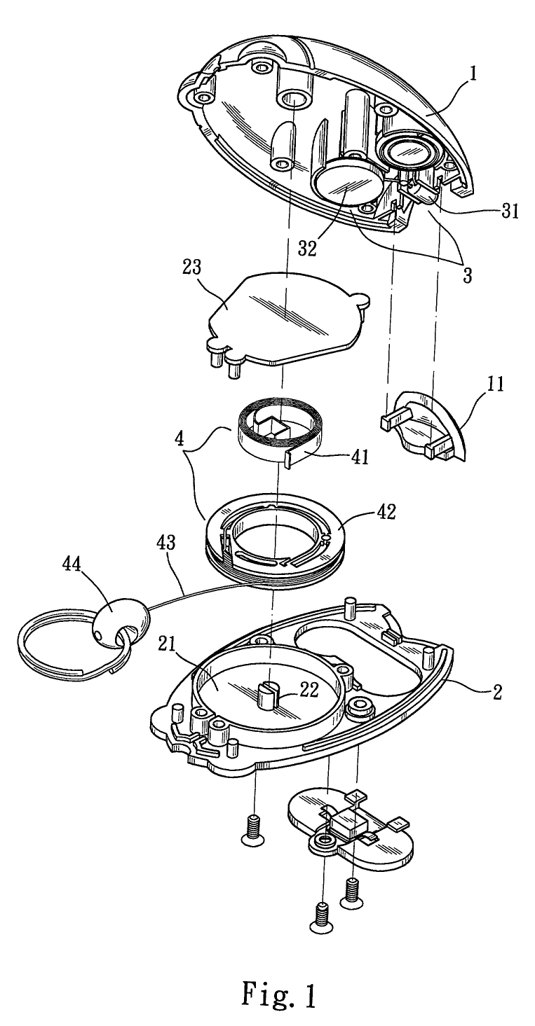

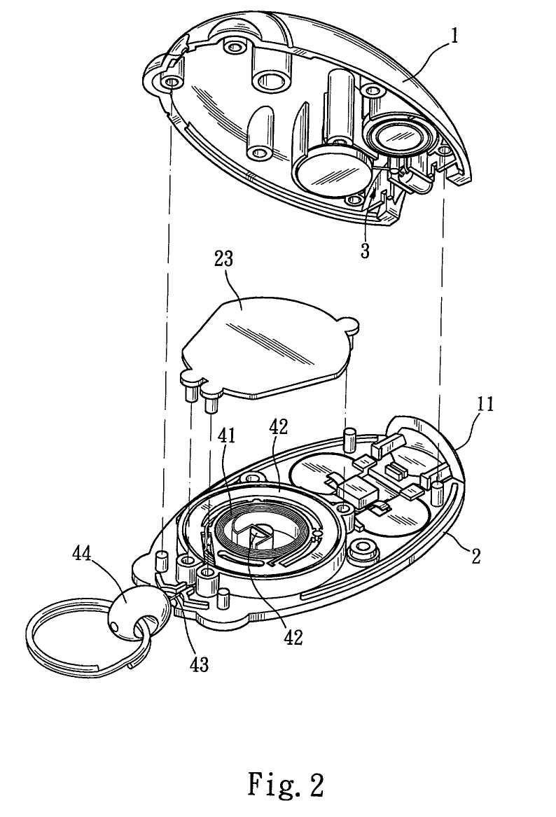

Please refer to FIGS. 1 and 2. The illuminator of the present invention includes a casing 1 and a corresponding base seat 2 mated with the casing 1 to define therebetween a chamber. In the chamber are disposed a light emitting unit 3 and a pulling device 4. The light emitting unit 3 is composed of a light source 31 and a cell 32. One end of the casing 1 is provided with a transparent or semitransparent illumination section 11 in which the light source 31 is disposed. The base seat 2 is formed with a receptacle 21 in which a boss 22 is disposed. The pulling device 4 is arranged in the receptacle 21 and covered by a press board 23 to block a backward path thereof. The pulling device 4 is composed of a resilient member 41 (such as a coiled spring) and a cord reel unit 42 in which the resilient member 41 is fitted. One end of the resilient member 41 is fixed on the boss 22 of the base seat 2, while the other end thereof is inlaid in the cord reel unit 42. A pull cord 43 is wound around the cord reel unit 42. At least one end of the cord 43 extends out of the cord reel unit 42 and connected with a fastening member 44. The resilient member 41 provides an automatically retracting and winding force for the cord 42. In use, the fastening member 44 is fastened on a wear or an article carried by a user. When used, the user can pull the illuminator outward for illumination. After used, the resilient member 41 through the pull cord 43 automatically pulls back and restores the illuminator to its home position. Therefore, it is unnecessary for the user to keep holding the illuminator so that it is convenient for the user to carry and use the illuminator.

The casing 1 and base seat 2 can be designed with various patterns as desired.

In addition, the end of the cord 42 extending out of the casing 1 can be connected with a holder 5. The holder 5 is formed with a cavity 51 in which a magnet 52 is disposed. Another magnet 24 is also disposed on the base seat 2. After retracted, the magnets 52, 24 can attract each other to retain the illuminator on the holder 5.

The above embodiments are only used to illustrate the present invention, not intended to limit the scope thereof. Many modifications of the above embodiments can be made without departing from the spirit of the present invention.

What is claimed is:

1. Illuminator with pull cord, comprising a casing, a light emitting unit and a pulling device, the casing being formed with an interior chamber in which the light emitting unit and the pulling device are disposed, the pulling device being composed of a resilient member and a cord reel unit connected with the resilient member, a pull cord being wound around the cord reel unit, at least one end of the pull cord extending out of the casing and connected with a fastening member, whereby after used, the resilient member through the pull cord can automatically resiliently pull back the illuminator.

2. Illuminator with pull cord as claimed in claim 1, wherein the light emitting unit is composed of a light source and a cell.

3. Illuminator with pull cord as claimed in claim 1, wherein one end of the casing is provided with a transparent or semitransparent illumination section in which the light source is disposed.

4. Illuminator with pull cord as claimed in claim 1, wherein a base seat is mated with the casing, the base seat being formed with a receptacle in which the pulling device is disposed.

5. Illuminator with pull cord as claimed in claim 4, wherein the pulling device is covered by a cover board.

6. Illuminator with pull cord as claimed in claim 4, wherein the pulling device is composed of a resilient member and a cord reel unit in which the resilient member is fitted, one end of the resilient member being fixed on a boss of the base seat, while the other end thereof being inlaid in the cord reel unit, a pull cord being wound around the cord reel unit, at least one end of the cord extending out of the cord reel unit and connected with a fastening member.

7. Illuminator with pull cord as claimed in claim 1, wherein the end of the pull cord extending out of the casing is connected with a holder provided with a magnet, another magnet being disposed on the base seat, whereby the magnets can attract each other to retain the casing of the illuminator on the holder.
